(19) United States
(12) Patent Application Publication
(10) Pub. No.: US 2014/0122196 A1
(43) Pub. Date: May 1, 2014

(54) SECURE VAULT FOR ONLINE-TO-OFFLINE TRANSACTIONS

(71) Applicant: YUB, INC, MOUNTAIN VIEW, CA (US)

(72) Inventors: Wanchung Cheung, Saratoga, CA (US); Gyuchang Jun, Sunnyvale, CA (US); Kevin Martin Sun, Menlo Park, CA (US); Jijo J. Varghese, San Jose, CA (US)

(73) Assignee: YUB, INC, MOUNTAIN VIEW, CA (US)

(21) Appl. No.: 13/835,288

(22) Filed: Mar. 15, 2013

Related U.S. Application Data
(60) Provisional application No. 61/719,850, filed on Oct. 29, 2012.

(51) Int. Cl. G06Q 30/02

(52) U.S. Cl. CPC G06Q 30/0211
USPC 705/14.13

(57) ABSTRACT

Systems and methods are disclosed for providing online offers for rewards that can be tracked to offline transactions for redemption. In order to protect sensitive consumer information, payment processing details such as credit card numbers and other authorizing data are redirected through a secure network to payment processing platforms, and then tokenized for subsequent use in relatively less secure data network communications and transactions. After a secure payment processing platform has authorized a transaction such as a reward for purchases, the payment processing platform can detect qualifying retail activity and generate corresponding rewards, which may be signaled to the customer through any suitable communications medium.

### CROSS-REFERENCE TO RELATED APPLICATIONS

This application claims the benefit of U.S. Provisional Patent Application No. 61/719,850 filed Oct. 29, 2012, which is hereby incorporated by reference in its entirety.

### BACKGROUND

A variety of techniques exist for tracking the use of rewards such as discounts, promotions or the like that are offered online. For example, a user may receive a coupon that can be printed out and redeemed at a retail store. Or a user may receive a reward code or the like that can be presented online or offline to receive a discount or other reward. While these techniques can be deployed in various ways to facilitate tracking, they generally require a consumer to retain and present a physical or virtual coupon, code, or other identifier in order to verify the offer for redemption and/or track the offer back to a specific distribution network.

There remains a need for improved techniques to track transactions from online contexts to offline contexts such as point of sale purchases.

### SUMMARY

Systems and methods are disclosed for providing online offers for rewards that can be tracked to offline transactions for redemption. In order to protect sensitive consumer information, payment processing details such as credit card numbers and other authorizing data are redirected through a secure network to payment processing platforms, and then tokenized for subsequent use in relatively less secure data network communications and transactions. After a secure payment processing platform has authorized a transaction such as a reward for purchases, the payment processing platform can detect qualifying retail activity and generate corresponding rewards, which may be signaled to the customer through any suitable communications medium.

### BRIEF DESCRIPTION OF THE FIGURES

The invention and the following detailed description of certain embodiments thereof may be understood by reference to the following figures:

FIG. 1 shows an environment for online-to-offline transactions.

FIG. 2 shows an online offer for an offline reward.

FIG. 3 shows a system for securely receiving sensitive information.

FIG. 4 shows a system for transacting with sensitive information.

FIG. 5 shows a method for selecting a payment processing platform.

FIG. 6 shows a method for selecting a tracking platform.

FIG. 7 shows a method for tracking usage of affiliate networks.

### DETAILED DESCRIPTION

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus for example the term “or” should generally be understood to mean “and/or” and so forth.

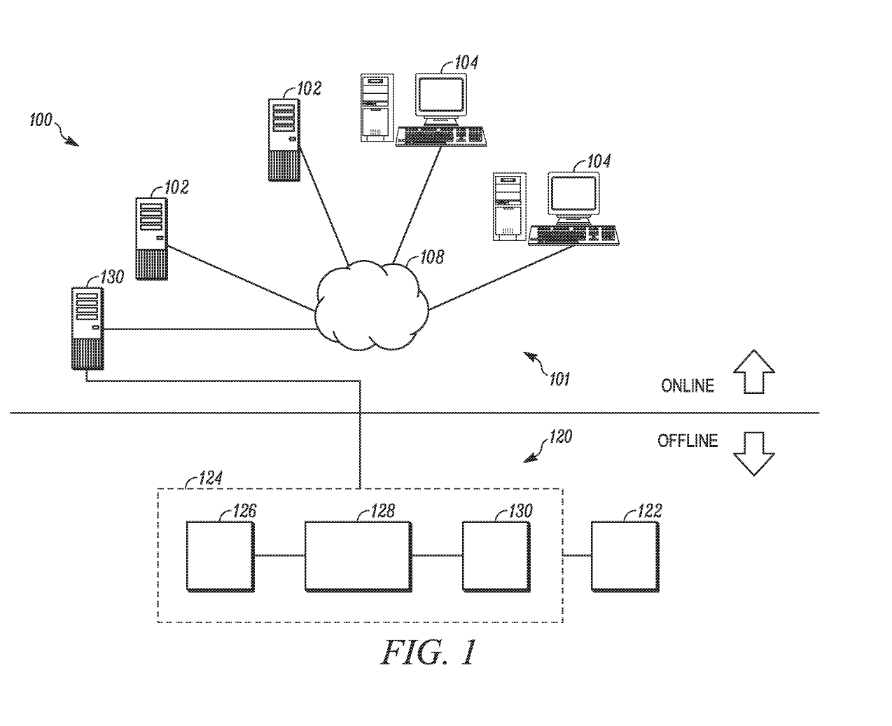

FIG. 1 shows an environment for online-to-offline transactions. The environment 100 may, by way of example, include an online environment 101 with any number of online entities such as servers 102 and clients 104 coupled to a data network 108 such as the Internet.

The server 102 may be any server or similar device coupled in a communicating relationship to the data network 108 and configured to support communications with other devices through the data network 108. The server 102 may for example be a web server or any other server configured to respond to requests from other devices with web content, or to otherwise host sessions or other communications with connected devices. Although illustrated as discrete physical objects, it will be understood that the servers 102 may include any number of logical or physical devices, and combinations thereof, suitable for providing the services contemplated herein. The number, configuration, capabilities, and arrangement of servers 102 may be adapted as a matter of design to any desired specifications, such as service levels, transaction capacities, speed and so forth. Servers may generally provide a variety of functions related to online-to-offline transactions as contemplated below.

In one aspect, the server 102 may provide a content landing page that can be visited directly by a client 104 searching for offers. The content landing page may include an offer for a reward such as a discount or cash credit contingent upon a specific user activity. In another aspect, the server 102 may provide a landing page for the offer, which the client may access from a link provided by another web site or through some other online activity. For example, the client may access such a link provided through a social network, a social game, or other social environment; e.g., as described in U.S. patent application Ser. No. 13/027,773, entitled “Dynamically Serving Content to Social Network Members,” the entirety of which is incorporated by reference herein. The functions of such a server for managing, delivering, and tracking online-to-offline transactions are described generally below.

In order to support various promotions, the server 102 may, for example, include an administrative interface for promoters and advertisers to configure, issue, and track various promotions and rewards. Such a server 102 may also or instead include a customer interface to track various offers that are available to consumers. So for example where a customer activates multiple offers, the customer may determine which offers are still valid and available for use. Similarly, where an offer includes multiple activities (buy 5 items, or make 3 purchases, etc.), the status of these activities may be retrieved from the server 102 in order for the customer to determine what remaining steps are required to receive a reward.

A client 104 may be any device suitable for accessing the data network 108 and the servers 102 coupled thereto. This may for example include a desktop computer, a laptop computer, a tablet, a cellular phone, a smart phone, or any other fixed or portable computing device with suitable network access. It will be appreciated that the data network 108 may include the Internet as well as any other peripheral private or public networks supporting communications including without limitation local area networks, metropolitan area networks, corporate area networks, and/or any wireless networks using, e.g., WiFi, WiMax, or 3G, 4G, LTE or other cellular networks or the like to support data communications.

An offline environment 120 may include a number of entities that are not connected directly to the data network 108. This may, for example include a point of sale 122 such as a retail store or other outlet or the like. It will be understood that such entities may also be connected to the data network 108, and may communicate with remote resources using a virtual private network or the like to secure communications containing sensitive information. Such entities may also use connections to the data network 108 for other, non-secure communications. However, financial transactions initiated at a retail point of sale or the like through a payment processing system 124 do not use public data networks such as the Internet, and the payment processing system 124 is not connected to the data network 108 in the sense contemplated herein. Where such financial transactions are initiated through a public data network (e.g., on a website or using a portable credit card reader accessory), data is heavily encrypted for communication to a secure access point within the “offline” payment processing platform, typically using the Payment Card Industry (PCI) Security Standards Committee's Data Security Standards (DSS) (commonly referred to as PCI-DSS) or an equivalent security infrastructure. Such communications are not a connection to a public data network as contemplated herein, and would not be expected or conventionally employed in a client device that is used to browse the data network 108 and initiate an offer/reward transaction online as described below. Thus in one aspect, the data network 108 uses a first security protocol configured to be suitable for general Internet communications the payment processing system 124 uses a second security protocol configured to be suitable for secure communication of financial information, personal information, or other correspondingly sensitive information. The security protocol used for the payment processing system 124 will in general be more secure than the security protocol used by the data network 108, although this is not universally true because a particular communication over the data network 108 may be secured using any protocols, encryption technologies, and the like that might be agreed to and supported by two communicating endpoints. It is nonetheless typically the case that the payment processing system 124 will operate using acceptable industry standards such as PCI-DSS that provide significantly greater security than general Internet communications.

The offline environment 120 may include a payment processing system 124 with a number of payment processing platforms such as one or more consumer banks 126, one or more payment card providers 128, and one or more merchant banks 130. In general, the payment processing platforms operate to transfer funds in support of a transaction such as a purchase at the point of sale 122 by accessing a suitable source of funds from a customer and transferring the funds to a merchant bank for a vendor operating the point of sale 122.

The consumer banks 126 may include any retail banks that maintain accounts for consumers and other end users. This may include an issuing bank that issues an ATM card, debit card, check card, credit card, prepaid card, or the like to the consumer for use in transactions. It will be understood that such a card may also be associated with one or more other payment processing platforms that participate in transactions by the card holder.

The merchant banks 130 may include any commercial banks that maintain accounts for corporate customers such as retailers and other vendors. In general, a merchant bank 130 may be a merchant acquiring bank that underwrites transactions for a merchant, and may provide point of sale hardware and services to support retail transactions, and/or back-end support for online purchases.

The payment card providers 128 may include any providers of debit, credit, or prepaid card networks for use by consumers such as Visa, MasterCard, Discover, American Express, and so forth. In a typical transaction, the consumer bank 126 and the merchant bank 130 will be predetermined by the identity of the customer initiating a transaction and the identity of the merchant operating the point of sale 122 (although this is not necessarily always the case). By contrast, a consumer may have a number of different payment cards, and the particular card selected for a transaction (and the corresponding payment card provider 128 used to complete the transaction) may vary significantly.

It will be understood that a variety of other entities may participate in a transaction, and may provide payment processing platforms that operate together with or independently from the other payment processing platforms described above. For example, certain commercial entities provide services such as aggregating card issuing bank data, providing an API layer for one or more merchant banks, and so forth. In other circumstances, a particular entity may have end-to-end relationships with consumers and merchants that permit a single entity to serve as the exclusive payment processing platform for a transaction. All such entities and combinations thereof are intended to fall within the scope of the term “payment processing platform” as used herein.

While entities within the online environment 101 may use a variety of security protocols to protect transactions such as HTTPS and various forms of end-to-end encryption that prevent clear text transmission of sensitive information, the payment processing platforms within the payment processing system 124 of the offline environment 120 generally operate using a different set of substantially more stringent security protocols consistent with transacting in funds and related handling of sensitive information such as credit card numbers, bank account numbers, personal identifying information, and so forth. For example, one commonly used set of security standards is PCI-DSS, which provides a framework for payment card data security processes. While these standards provide wholly appropriate protections for sensitive personal and financial information, they are generally inconsistent with security protocols used in public data networks.

In order to bridge this gap in security protocols without imposing computationally, logistically, and financially expensive security requirements on other participants in the data network, a secure vault 130 may be provided that uses a first interface to the data network 108 that operates according to a first security protocol generally consistent with networked communications through the data network 108, and that uses a second interface to the payment processing system 124 of the offline environment 120 that operates according to a second security protocol suitable for handling of sensitive information used in financial transactions. While the secure vault 130 is depicted as coupling to the data network 108, other configurations are possible. For example, the secure vault 130, which may be implemented as a private cloud coupled to another server that provides an interface to the data network 108, or a virtualized private cloud remotely located with an exclusive, dedicated point-to-point connection to such a server. The second interface may use a private connection or other similarly exclusive interface for secure communications with the payment processing system 124.

The secure vault 130 is described in greater detail below. By providing this intermediary between online participants and offline or otherwise secure payment processing infrastructure, a system is provided for transparent (to the customer) tracking of reward redemptions. In general, such a system includes systems and methods for creating a promotion, receiving user activation of the promotion online, tracking related activity offline, and then providing a reward.

The promotion may be created for example as a self-referential offer which may be configured by an advertiser and provided to the advertiser as a link or unique identifier associated with the promotion. The self-referential offer may be distributed in any desired manner by the advertiser such as by placement on a web site or in an electronic mail, or in any other manner suitable for online distribution. The offer may contain or be coupled with a pointer such as a hyperlink back to a server that supports online activation of the offer by a consumer. The advertiser may configure a variety of parameters for a promotion such as a start and end date, a redemption period or expiration date, a transaction limit (e.g., maximum number of offers activated by a unique user within a time period), a geographic restriction, and so forth. The advertiser may also configure multiple eligible activities, e.g., with dollar amounts or number of purchases that are required, and may select one of the multiple options at the time that the offer is presented to a user, or present multiple options to the user for selection of one by the user.

During online activation, a user that receives the promotion may activate the offer by providing identifying information such as a credit card number. In addition to a confirmation of the activation, the user may receive other relevant information such as a map showing retail locations where the offer can be completed, an expiration date, and so forth.

The identifying information may be used by a tracking partner such as a credit card company or other payment processing platform to detect when a qualifying event such as an offline purchase has occurred. It will be understood that this event may also or instead include an online purchase. After the qualifying event, a reward may be issued such as by providing to the user a virtual currency, a digital good (software, media, etc.), a statement credit, or the like. In addition, affiliate revenue share may be calculated according to the distribution channel for the promotion. The tracking partner may, upon detecting the qualifying event, send a notification to the server 102 which may in turn notify the user. Where the tracking partner has a relationship with the user (e.g., a credit card provider that has issued a card to the user), the tracking partner may directly provide a statement credit that will appear on the user's next statement from the tracking partner. With suitable relationships with merchant banks, or where a merchant bank is a tracking partner, a discount may be directly applied at a point of sale for the qualifying event. More generally, any suitable arrangement that is agreeable to participating payment platforms and tracking partners may be used to provide a reward to a user after a qualifying event. In general, by selecting a tracking partner within the offline environment 120, a qualifying event can be detected without any need for a user to provide discrete coupons, codes or the like.

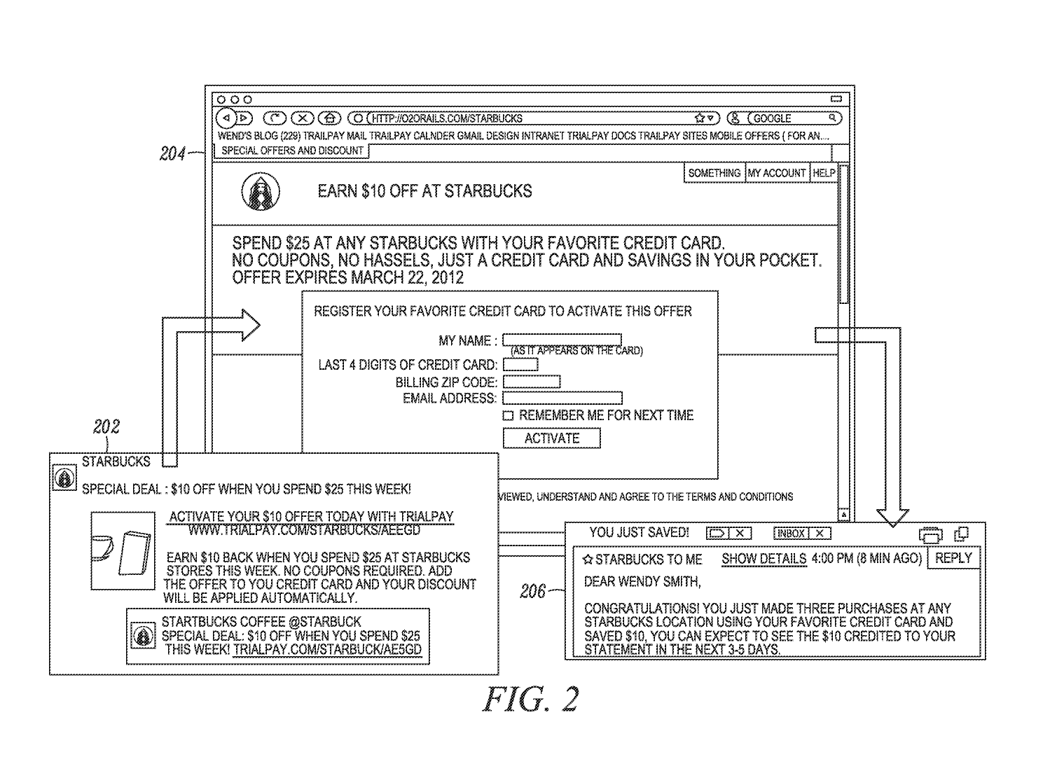

FIG. 2 shows an online offer for an offline reward. The online offer may include an offer 202 distributed, e.g., in an electronic mail, text or multimedia message, or the like, or presented on a web page that the user visits or an application that the user runs. The offer 202 may include a link to a server for activating the offer, which link (or other pointer) may include information uniquely identifying the promotion to which the offer relates. When a user navigates to the server using the link, the server may responsively identify the corresponding promotion and present an offer activation page 204.

The offer activation page 204 may include a request for identifying information such as a name, electronic mail address, billing zip code, credit card number (or a portion thereof), and any other relevant information. Where a user has previously registered with the server, the user may provide sufficient information for positive identification. Where the user has not previously registered, the server may request more detailed information, such as information required to authorize a credit card transaction and to contact the user concerning the offer.

After the activation is complete, the user may simply engage in a corresponding offline activity (i.e., purchasing coffee with the credit card identified during activation) and a corresponding reward can be automatically created and credited to the user, with a notification 206 sent by electronic mail, SMS message, or any other suitable communication to the user.

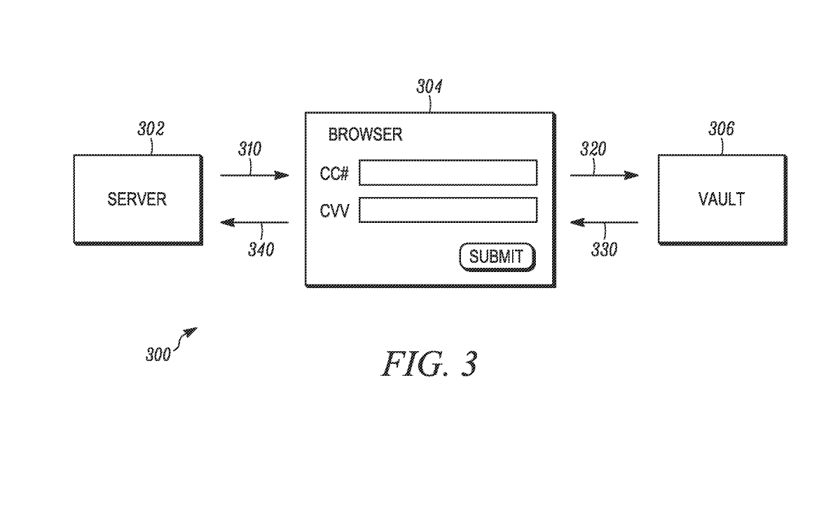

FIG. 3 shows a system 300 for securely receiving sensitive information. In order to detect offline activity eligible for a reward, a system may interface with any appropriate payment processing platform(s) such as a consumer bank of the user, a merchant bank of the offeror, a payment card platform for which the user has an account, or some other payment processing platform. However, this generally requires the collection of sensitive information from an intended user and tracking by the payment processing platform. The following system uses a secure vault to gather such sensitive information in a manner consistent with any applicable industry standards for data security.

Although not depicted in FIG. 3, it will be understood that an offer may be created by an advertiser and distributed as a self-referential advertisement that can be freely circulated in a digital environment. The self-referential advertisement may include a unique identifier and a link to a server. The unique identifier may uniquely identify a particular offer, and the server identified in the link may be configured to respond to the unique identifier by presenting the offer, along with a request for additional information needed to activate the offer for a user. In this manner, a user may reach the server 302 in a variety of ways according to the distribution network for the self-referential advertisement.

The server 302, which may be any of the servers described above, may in general present a request for registration information or the like in a landing page from a remote web site or other source that published the self-referential advertisement described above. The server 302 may present content 304 such as an HTML form or other browser-compatible data to a client device (as shown by a first arrow 310). This content 304 may be transmitted to the client using a secure socket layer or any other suitable HTTP-compatible technology for securing the transmission of content and/or authenticating an identity of the server 302. The content 304 may include an offer that can be displayed on the client, along with a request for information needed to track a corresponding offline transaction. Information may be provided from the client in response to the request, such as by filling out an HTML form. Where sensitive information such as personally identifiable and/or financial information (e.g., a social security number, birthday, account number, credit card number (CC#), credit card expiration date, Card Verification Value (CVV), etc.) is requested, a JavaScript code within the content 304 on the client may capture and forward user responses directly to a secure vault (as shown by a second arrow 320) using any suitable encryption or the like to conceal the sensitive information. This may, for example, include the use of any data security standards or protocols suitable for Internet transmission of sensitive information, such as those prescribed by PCI-DSS, the entire content of which is hereby incorporated by reference.

In response to the receipt of such data from the client, a secure vault 306 may store the sensitive information, create a token corresponding to the sensitive information, and return the token to the client. It will be understood that the third arrow 330 signifying the reply token points toward the content 304, which in this context also represents the client that is displaying the content 304. The client may then combine the token with any other nonsensitive data from the form and transmit this combined data to the server 302 (as shown by a fourth arrow 340). As a significant advantage, in this configuration the server 302 never sends or receives sensitive information, and need not be maintained to the rigorous security standards used for handling sensitive information.

Having stored the sensitive information in this manner, the secure vault 306 may then respond to requests containing the token with the sensitive information, or data representative or derivative of the sensitive information. The token does not inherently contain any sensitive information, and as such a request containing the token may be transmitted over any conventional data network or stored in any desired manner with little or no security risk to the user that provided the corresponding information. However, the response from the secure vault 306 may contain sensitive information, and as such, replies to token inquiries may be transmitted through a second interface of the secure vault 306, for example a secure interface to one or more payment processing platforms operating according to the PCI SSC DSS or any other standard(s) providing suitable security for the sensitive information.

Thus in one aspect there is disclosed herein a system including a first server coupled to a public data network and communicating according to a first security protocol (e.g., the server 302) and a second server having a first interface coupled to the public data network and a second interface coupled to a secure payment processing network according to a second security protocol (e.g., the secure vault 306). The first server may be configured to present a request for an item of sensitive information to a client through the data network, wherein the request is further configured to receive the item at the client and securely forward the item from the client to the second server. The second server (e.g., the secure vault) may be configured to securely receive the item from the client through the first interface, and further configured to create a token representative of the item and to return the token to the first server through the first interface. This may include transmitting the token directly to the first server, or relaying the token through the client that initiate the request for a token. The second server may stores a relationship between the item and the token in order for the second server to respond to appropriate requests based upon the token.

The second server may be configured to respond to a second request from the first server through the first interface containing the token by performing the steps of: transmitting the item of sensitive information to a payment processing platform through the second interface; receiving a transaction identifier from the payment processing platform through the second interface; and transmitting the transaction identifier to the first server through the first interface.

The second security protocol may be compliant with the Payment Card Industry (PCI) Security Standards Committee (SSC) Data Security Standards (DSS), which is incorporated by reference herein in its entirety. The second server may more generally be compliant with one or more PCI SSC data security protocols. At the same time, the first server is relieved of handling sensitive information, and need not be compliant with the PCI SSC Data Security Standards or any other heightened security standards or protocols.

Using the system described above, a landing page for a self-referential advertisement may present an offer to a user at a client that can be redeemed using an item of sensitive information such as a credit card number at a point of sale.

In one aspect, a promotion may be configured to deterministically use a predetermined payment processing platform, such as where a credit card issuer sponsors a discount for purchases made using the issuer's card. In another aspect, the server 302 may select one of a plurality of different payment processing platforms for an offer. In this manner, the server 302 may auction a right to process the transaction (and receive any corresponding processing fees) at the time that a user activates the offer, and the offer may be limited from the user's perspective to a single platform, e.g., a payment card network such as Visa or MasterCard, that won such an auction.

In another aspect, the server 302 may select and present to the user a plurality of different offers from a plurality of payment processing platforms. Thus for example, a number of different payment card networks may be offered, and the user may select one of the different payment card networks for executing a subsequent offline transaction. Where multiple options are provided, each option may provide an identical offer, or each option may be associated with a different offer. Similarly, amounts and types of discounts or other rewards may be varied on a platform-by-platform basis. So for example a number of payment card networks may be presented with a reward of a $5 discount, while one payment card network may provide the same offer with a reward of a $10 discount. The various rewards may be predetermined by each payment processing platform, or the right to offer various reward may be auctioned substantially in real time so that various card networks and the like can compete for the right to process an offline transaction. Similarly, the various card networks or other payment processing platforms may compete on the basis of an amount of reward or discount to offer.

Thus in general the server may select one or more of a plurality of payment processing platforms for an offer that is presented to a user. Where the server presents a plurality of offers, the server may preferentially promote one of the plurality of offers in a variety of ways, such as by varying the content of the offers relative to one another or by varying the placement of each offer within content displayed on a client.

It will be understood that the offer may take a variety of forms. For example the offer may include a discount for a purchase at a point of sale, or the offer may be a multi-part offer that includes a discount following a number of purchases. The offer may also include multiple components (e.g., $10 off the first $100 spent, or $20 off the first $150 spent), and the offer may include geographic constraints, time constraints, and any other suitable objective parameters or criteria that might be used to define the conditions for receiving a reward.

An administrative interface may be provided to advertisers for configuring such promotions and offers. Thus in one aspect the system may include a third server configured to receive promotion information from an offeror, and to provide a unique identifier for a unique offer to the offeror. The unique identifier may be used as described above to provide a self-referential deal or advertisement that can be distributed using any available digital networks or media by the offeror. The third server or some other server may, in general, respond to the unique identifier by providing a link to the landing page described above through which a user can activate an offer. This third server may be the same as the server 302 described above, or a logically and/or physically separate server configured for use by advertisers to create and deploy promotions.

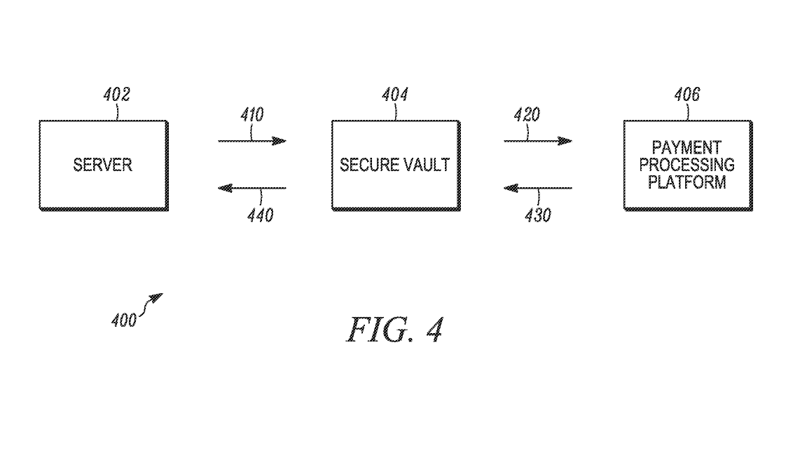

FIG. 4 shows a system 400 for transacting with sensitive information. While the previous description focuses on the public-facing network for the creation, distribution, and activation of promotions, the sensitive information acquired for offline tracking must subsequently be accessed in order to detect and/or track completion of an offer or to transmit offer information to a payment processing platform for tracking. As shown in FIG. 4, a third party payment processing platform may use an HTTP-based API to access data stored in the secure vault on the basis of a token such as the token described above. The vault may then act as an HTTP proxy to perform translations between a token on one hand and sensitive information such as a credit card number on the other.

This process may be initiated when a server 402 receives a third party request containing the token that is associated with an offer, or when the server 402 initiates a communication to the offline payment processing system. For example, this may take the form:

GET/auth?cc=token:1234&amount=4.00

Host: api.[hostname].com

The server 402 may forward the request with the token to a secure vault 404 as shown by a first arrow 410. The secure vault 404 may then substitute the credit card number for the token and forward the request (including the sensitive information) to the payment processing platform 406 using a suitably secure protocol as shown by a second arrow 420. This may take the form:

GET /auth?cc=4444000012344321&amount=4.00

Host: api.[hostname].com

The payment processing platform 406 may then process the requested transaction and respond to the secure vault 404 through the secure interface with a transaction identifier as shown by a third arrow 430. This transaction identifier may then be used to detect an offline transaction or to signal the detected transaction to a remote resource, as well as to allocate a reward to the user in any suitable manner. The transaction identifier may be returned to the server 402 as shown by a fourth arrow 440.

It will be noted that a specific payment processing platform may be referenced in the request to the secure vault 404, thus enabling a token-based transaction processing scheme that works across multiple processing platforms, any of which may participate in the initial offer activation and a subsequent reward/redemption phase using the secure vault 404.

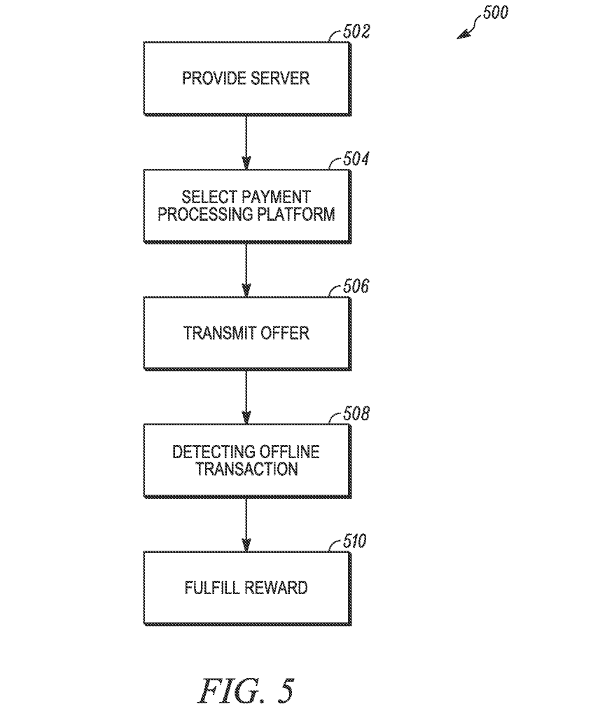

FIG. 5 shows a method for selecting a payment processing platform. In general, the method 500 may be used by a server such as any of the servers described above to select an entity to make an offer from among a number of different payment processing platforms such as card processing networks. On one hand, this permits payment processing platforms to compete on the basis of price for the right to process the transaction and collect any associate fees. On the other hand, this may be deployed to permit a user to choose from among different payment options according to, e.g., a preferred card or an amount of discount offered.

As shown in step 502, the method 500 may begin with providing a server, such as any of the servers described above, that presents an offer to a client. The offer may include a reward for an offline transaction. It will be understood that the reward may take a variety of forms. For example, the reward may include a discount on the offline transaction itself, which may be applied at a point of sale or received as a statement credit for the user, depending upon the capabilities of the payment processing platform selected to track the transaction. In another aspect, the reward may include a digital good, such as any item that is distributed through a digital network. This may for example be a virtual currency for an online game or the like, a gift certificate, software, a software token, a media file, a coupon (which may be redeemable for a physical good), a bar code, a two-dimensional bar code (such as a Quick Response (QR) Code), and so forth. In another aspect, the reward may be a physical good such as food, clothing, tools, office supplies, or any other good in physical form that might be provided as a reward. In another aspect, the offer and/or reward may be identified based at least in part on one or more characteristics of the user in one or more social networks, social games, or other social environments in which the user participates, e.g., as described in U.S. patent application Ser. No. 13/027,773. Such characteristics could include demographic characteristics of the user or the user's social connections, recent activity of the user within the social network, social game, or social environment, and the like.

As shown in step 504, the method may include selecting one of a plurality of payment processing platforms to redeem the reward, with the offer configured so that use of the selected platform to complete an offline transaction is a condition for receiving the reward. In general, the payment processing platform may be any of the payment processing platforms described above, and may operate as a tracking platform to track one or more qualifying events (e.g., purchases) for a user to receive the reward. This may include one or more credit card providers or one or more other payment card providers or other payment processing platforms, as well as combinations of these.

A variety of techniques may be used to select the payment processing platform from among a plurality of available payment processing platforms. For example, this may include selecting two or more of the plurality of payment processing platforms to redeem the reward and presenting these options to the user along with a control for the user to select one of the payment processing platforms to redeem the reward. This may also or instead include varying the reward for each of the payment processing platforms, wherein the user receives a greater benefit by selecting a certain one of the payment processing platforms. In another aspect, the payment processing platform may be selected when the offer is created by an advertiser, or the payment processing platform may be selected by auctioning the offer to the available payment processing platforms, thus permitting these entities to compete for the right to process a corresponding transaction. Where an auctioning technique is used, the offer may be auctioned at the time that an offer is presented (effectively in real time, with no observable latency to the user receiving the offer), or the offer may be auctioned before the offer is presented, in which case any number of criteria and techniques may be used to match bids from payment processing platforms with offers being served to clients.

As shown in step 506, the method 500 may include displaying the selected payment processing platforms in the offer.

As shown in step 508, the method 500 may include detecting the offline transaction. As described above, a user may provide identifying information when activating in offer. The identifying information may be used by a payment processing platform to detect when a transaction corresponding to the identifying information (e.g., matching a credit card or account number) occurs. In this manner, the payment processing platform may also serve as a tracking platform for qualifying events related to the offer and reward. The offline transaction may more generally be detected according to one or more predetermined criteria according to a capability of a particular payment processing platform. Verification that a particular transaction meets the requirements of the offer may be performed internally by the payment processing platform, or by communicating the transaction of aspects of the transaction to a remote server (e.g., a reward tracking server) for verification.

As shown in step 510, the method 500 may include fulfilling the reward through the selected payment processing platform. This may include providing a discount at the point of purchase, a statement credit, a coupon, or any other suitable reward according to the capabilities of the payment processing platform(s) and the desired benefit to the consumer.

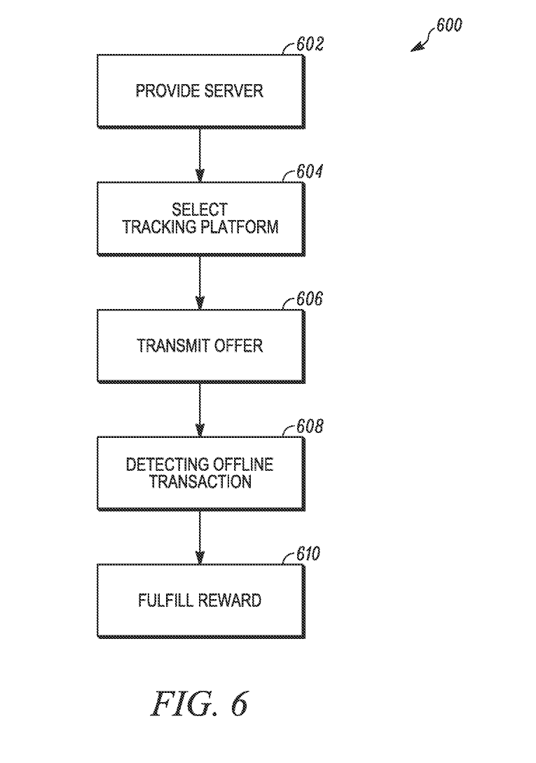

FIG. 6 shows a method for selecting a tracking platform. As described above, a server may be configured to support online-to-offline transactions. This server may support a selection from among a number of available payment processing platforms as described for example with reference to FIG. 5. The server may also or instead be configured to support selection from among a number of tracking platforms that are used to track the occurrence of offline transactions that entitle a user to receive a reward. In one aspect, the tracking platform may simply be the payment processing platform selected for the offline transaction. However, this is not required, and redemption of a reward may be tracked and processed by any payment processing platform involved in the transaction. For example, a merchant bank for a retailer may be used to track redemption of the reward, which may advantageously permit the immediate creation of a discount directly on a receipt for a qualifying transaction, or a store credit or other reward. As another example, where a user's credit card account is used to track redemption, the user may be issued a statement credit after completing a qualifying transaction.

As shown in step 602, a method 600 for selecting a tracking platform may begin with providing a server that is configured to respond to a predetermined identifier such as a self-referential advertisement by presenting an offer to a client such as a reward for an offline transaction.

As shown in step 604 the method 600 may include selecting one of a plurality of payment processing platforms to track a redemption of the reward, which may include detecting a qualifying event for the reward. The payment processing platform may, for example, include a card payment processing platform (such as a credit card network), a merchant bank, a consumer bank, or any intermediary or aggregator for transactions of any of the foregoing.

It will be noted that the selection described in FIG. 6 is somewhat different than selecting from among available platforms to process the payment as described above. That is, there may be multiple alternatives to process a payment, such as multiple credit card networks, any of which might be used in the alternative to process a payment. At the same time, a number of different platforms might be used sequentially to complete a transaction, any of which might be selected as the tracking platform to track redemption. For example, a user-specific technique might use any payment card or consumer bank account of the user. On the other hand, a merchant-specific technique might use a merchant bank or payment platforms associated with the merchant.

In one aspect, the tracking platform may be selected when an offer is created, such as when a promotion or campaign is configured that generates the offer or when a specific self-referential advertisement for such a campaign is created and/or distributed. In another aspect, the tracking platform may be selected when the offer is presented to a user for activation.

The selection of the tracking platform may be based upon an amount offered by each of the plurality of payment processing platforms to subsidize the reward. In this manner, the right to provide tracking data for fulfillment/redemption may be auctioned or otherwise disposed to one of the available tracking platforms willing to offer the greatest subsidy for the reward. The selection may also or instead be based upon one or more capabilities of each potential tracking platform. Capabilities may, for example, include an ability to immediately detect a point of sale transaction, an ability to provide a discount at the point of sale, an ability to provide a statement credit for the reward, an ability to issue coupons, an ability to view all transactions for a merchant bank, and so forth. It will be understood that the various tracking platforms contemplated herein are likely to be independent commercial entities competing for the opportunity to carry transactions, each providing various types of services and interfaces within a payment system. In one aspect, the tracking platform may be selected by comparing processing charges from such entities for providing tracking information and selecting the payment processing platform based upon fee structures. This may, for example include selecting the platform that has the lowest charges for providing tracking information such as detection of a qualifying offline transaction, or selecting the platform that has the lowest cost for processing a corresponding reward.

As shown in step 606, the method 600 may include transmitting the offer to the client from the server. This may, for example, including providing a landing page or the like for display by a browser executing on the client.

As shown in step 608, the method 600 may include detecting an offline transaction. This may, for example include detecting the transaction at a selected tracking platform or a predetermined payment processing platform, or this may include detecting the transaction at a server or other platform configured to track transactions or rewards.

As shown in step 610, the method 600 may include fulfilling the reward using any suitable technique consistent with the payment processing platform(s) used for the offline transaction, or otherwise based upon identifying information provided by a user.

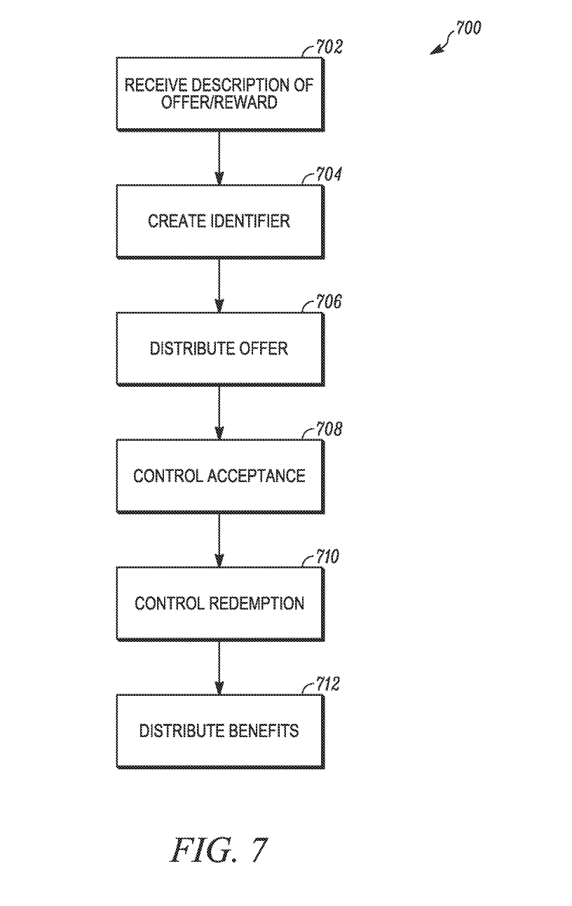

FIG. 7 shows a method for tracking usage of affiliate networks. In general, this form of tracking relates to the manner in which an offer is distributed. As described above, an offer may be encapsulated in a self-referential advertisement that can be provided to an advertiser, broker, agent, or the like, and distributed as desired through any digital medium. For example, the self-referential advertisement may be placed in a website, in electronic mail, in a Short Messaging Service (SMS) message, or any other suitable digital medium. In this context, it may be useful to provide tracking through affiliate networks in order to correspondingly allocate the economic benefit of an offer and reward.

As shown in step 702, a method 700 may begin with receiving a description of an online offer from a merchant, the offer including a reward for an offline transaction. This description may, for example, be entered using an administrative or merchant interface to an online-to-offline transaction server, and may include a specification of the value and nature of the reward, qualifying offline transactions, acceptable or recommended payment processing platforms and/or tracking platforms, geographic restrictions, time restrictions, and so forth.

As shown in step 704 the method 700 may include creating an identifier for the offer. This may, for example, include a unique identifier for the offer, along with a link or other reference to a server or other online resource that can be accessed to retrieve and/or activate the offer. In another aspect, this may include an identifier for a group or class of offers. In other words, the identifier need not uniquely identify a particular offer, but may instead refer to a group of offers that may be dynamically selected according to, e.g. a source or referring page from which the identifier is presented, information about a user or client device that requests the offer using the identifier, a date or time of day, or any other information or context that might be available at the time that the identifier is presented to an activation server or the like.

As shown in step 706, the method 700 may include distributing the offer. This may include distributing the identifier and any corresponding link or address information to one or more third parties such as content publishers or affiliate networks. An affiliate network may be any affiliate-based marketing network that provides a commercial intermediary between publishers and merchants for distributing offers and advertisements to customers. This may for example include a network that compensates various affiliates for each visitor or customer delivered to a retailer, merchant, or brand. Affiliates may, for example, produce web pages, create electronic mail marketing campaigns, or otherwise publish content containing links such as the self-referential advertisements described above, and may participate by way of referral fees in any resulting transactions.

More generally, using a variety of techniques, an offer may be distributed through web content, mobile device advertisements, in-game user interfaces or other dynamic content, social networks such as Facebook or Twitter, and so forth.

As shown in step 708, the method 700 may include controlling an acceptance of the offer. This may, for example, include presenting a landing page that contains the offer in response to receiving the identifier from a client. The landing page may request information used to activate the offer, including sensitive information such as a credit card number and personally identifying information such as an electronic mail address, name, and the like. As such, in one aspect controlling acceptance may further include requesting identifying information for a selected payment processing platform in the landing page and confirming that the user is an authorized user of the payment processing platform, e.g., through the secure vault described above.

As shown in step 710, the method 700 may include controlling a redemption of the reward for completing an offline transaction. This may include receiving a notification from a payment processing platform that the offline transaction has occurred. In order to confirm that the offline transaction qualifies for the reward, a variety of supplemental information may be exchanged. This may for example include a dollar amount spent, a number of items purchased, a sku number or the like to identify a specific product, and so forth. The relevant information may be provided by an offeror when the offer is initially configured (e.g., by providing the relevant sku numbers), or a candidate transaction may be referred to the offeror for validation, or some combination of these.

As shown in step 712, the method 700 may include distributing economic benefits associated with the completed offline transaction. For example, this may include distributing an allocation of an economic benefit of the offer to one or more entities in the at least one affiliate network based upon the acceptance. This may also or instead include distributing an allocation of an economic benefit of the offer to one or more entities in the at least one affiliate network based upon the redemption. More generally, the distribution through an affiliate network, and the subsequent processing of the offline transaction through one or more payment processing platforms, may be tracked using a variety of techniques and used to determine which entities are entitled to share in the economic benefit of a transaction, either through referral fees, handling or processing fees, and the like.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors, or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method or step described above and combinations thereof may be realized as a computer program product comprising computer executable code embodied in a computer readable medium (such as a non-transitory computer readable medium) that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

It should further be appreciated that the methods above are provided by way of example. Absent an explicit indication to the contrary, the disclosed steps may be modified, supplemented, omitted, and/or re-ordered without departing from the scope of this disclosure.

The method steps of the invention(s) described herein are intended to include any suitable method of causing such method steps to be performed, consistent with the patentability of the following claims, unless a different meaning is expressly provided or otherwise clear from the context. So for example performing the step of X includes any suitable method for causing another party such as a remote user or a remote processing resource (e.g., a server or cloud computer) to perform the step of X. Similarly, performing steps X, Y and Z may include any method of directing or controlling any combination of such other individuals or resources to perform steps X, Y and Z to obtain the benefit of such steps.

While particular embodiments of the present invention have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

1. A system comprising:
a first server coupled to a public data network and communicating according to a first security protocol and a second server having a first interface coupled to the public data network and a second interface coupled to a secure payment processing network according to a second security protocol, wherein the first server is configured to present a request for an item of sensitive information to a client through the data network, and wherein the request is configured to receive the item at the client and securely forward the item from the client to the second server, and
wherein the second server is configured to securely receive the item from the client through the first interface, the second server further configured to create a token representative of the item and to return the token to the first server through the first interface, wherein the second server stores a relationship between the item and the token and wherein the second server is configured to respond to a second request from the first server through the first interface containing the token by performing the steps of:
transmitting the item of sensitive information to a payment processing platform through the second interface;
receiving a transaction identifier from the payment processing platform through the second interface; and
transmitting the transaction identifier to the first server through the first interface.

2. The system of claim 1 wherein the second security protocol is compliant with the Payment Card Industry (PCI) Security Standards Committee (SSC) Data Security Standards (DSS).

3. The system of claim 2 wherein the second server is compliant with one or more PCI SSC data security protocols.

4. The system of claim 1 wherein the second security protocol is configured to be suitable for secure communication of financial information or personal information.

5. The system of claim 1 wherein the first security protocol is configured to be suitable for general Internet communications.

6. The system of claim 5 wherein the second security protocol is configured to be more secure than the first security protocol.

7. The system of claim 1 wherein the request includes a JavaScript code that forwards the item of sensitive information from the client to the second server.

8. The system of claim 1 wherein the first server provides the request in a landing page from a remote website.

9. The system of claim 1 wherein a landing page presents an offer to a user at the client, and wherein the offer is redeemed using the item of sensitive information at a point of sale.

10. The system of claim 9 wherein the offer includes a reward for a transaction using the payment processing platform, the system further comprising a third server configured to receive a notification of the transaction from the payment processing platform and further configured to notify a user that provided the item of sensitive information of the reward.

11. The system of claim 9 wherein the first server selects one of a plurality of payment processing platforms for the offer.

12. The system of claim 9 wherein the first server presents a plurality of offers from a plurality of payment processing platforms to the client.

13. The system of claim 12 wherein the first server preferentially promotes one of the plurality of offers when presenting the plurality of offers to the client.

14. The system of claim 9 wherein the offer includes a discount for a purchase at the point of sale.

15. The system of claim 9 wherein the offer is a multi-part offer that includes a discount following a number of purchases.

16. The system of claim 9 further comprising a third server, the third server configured to receive promotion information from an offeror, and to provide a unique identifier for a unique offer to the offeror.

17. The system of claim 9 wherein the offer is identified based on one or more characteristics of the user in one or more social networks, social games, or social environments.

18. The system of claim 17 wherein the one or more characteristics include a characteristic selected from the group consisting of a demographic characteristic and recent activity within the one or more social networks, social games, or social environments.

19. The system of claim 16 wherein the third server is the first server.

20. The system of claim 16 wherein the third server responds to the unique identifier with a link to the landing page.

21-80. (canceled)
